(19) United States
(12) Patent Application Publication
(10) Pub. No.: US 2026/0219548 A1
(43) Pub. Date: Jul. 30, 2026

(54) QUANTUM ENTANGLEMENT PROTOCOL FOR A QUANTUM INTERCONNECTION DEVICE

(71) Applicant: IONQ INC., College Park, MD (US)

(72) Inventors: David Sarkis Levonian, Boston, MA (US); Johannes Borregaard, Cambridge, MA (US); Mihir Keshav Bhaskar, Cambridge, MA (US); Bartholomeus Johannes Machielse, Brighton, MA (US)

(73) Assignee: IONQ INC., College Park, MD (US)

(21) Appl. No.: 19/176,907

(22) Filed: Apr. 11, 2025

Related U.S. Application Data
(60) Provisional application No. 63/749,189, filed on Jan. 24, 2025.

(51) Int. Cl. G02F 3/00

(52) U.S. Cl. CPC G02F 3/00

(57) ABSTRACT

Methods and systems for executing quantum entanglement protocols at a quantum interconnection device are disclosed. In order to provide distributed quantum entanglement between at least two external quantum devices, a quantum interconnection device is configured to receive entangled photons from those external quantum devices, store the corresponding quantum information within optically active quantum memories, and subsequently perform operations between the memory qubits of the optically active quantum memories, thus establishing quantum entanglement between the external devices. By heralding the successful transfer of quantum information to the memory qubits, the quantum entanglement protocol can be performed within the time limits set by decoherence of various types of qubits, and at a faster rate.

### CROSS REFERENCE TO RELATED APPLICATION

This U.S. Non-Provisional Patent Application claims the benefit of and priority to U.S. Provisional Patent Application Ser. No. 63/749,189, entitled “Quantum Entanglement Protocol for a Quantum Interconnection Device,” filed Jan. 24, 2025, and which is incorporated herein by reference in its entirety.

### TECHNICAL FIELD

The present disclosure relates to methods and systems for receiving optical signals at a quantum interconnection device and subsequently establishing quantum entanglement between two or more quantum devices that are external to the quantum interconnection device, based on those received optical signals.

### BACKGROUND

Quantum computers offer fundamentally new tools for resolving problems which are, at the time of writing, computationally intractable on classical computers. Realizing this potential requires the development of new hardware that takes advantage of the quantum properties of superposition and entanglement, neither of which are accessible on classical computers. Significant progress has been made to lower computation error rates and increase physical qubit counts, such that sets of physical qubits can now be assembled into “logical qubits” which have error rates lower than their constituent qubits. This constitutes a fundamental step towards the creation of fully “error corrected” quantum computers, which are required to solve most useful, real-world problems.

However, in order to reach commercial relevance, the number of physical qubits within a given quantum computer also still needs to be drastically scaled up, which further limits the current error correction and mitigation techniques available at the time of writing. While qubit counts continue to grow for some quantum computing platforms, most systems have begun to reach fundamental limits on how many qubits can be operated within a single processor. For these systems, further increases in qubit density will either increase crosstalk, slow gate times, or require fundamental re-engineering of their hardware.

### BRIEF DESCRIPTION OF THE DRAWINGS

FIG. 1A illustrates a quantum interconnection device that is connected, via optical communication links, to various external quantum devices, according to some embodiments.

FIG. 1B illustrates a first moment in time during which the quantum interconnection device that is introduced in FIG. 1A is configured to receive various optical signals (e.g., entangled photons) from various external quantum devices (e.g., a quantum processing unit (QPU), a quantum repeater, a quantum sensor), and subsequently begin executing a quantum entanglement protocol, according to some embodiments.

FIG. 1C illustrates a second moment in time during which the quantum interconnection device that is introduced in FIG. 1A is configured to receive additional optical signals from the various external quantum devices, according to some embodiments.

FIG. 2 additionally illustrates components of a quantum interconnection device, including a given implementation of memory qubits as being mapped to components of silicon-vacancy (SiV) cavities, according to some embodiments.

FIGS. 3A, 3B, 3C, 3D, and 3E illustrate respective moments in time during execution of a quantum entanglement protocol in which multiple quantum memory modules of the quantum interconnection device are used in order to establish entanglement between two external quantum devices, according to some embodiments.

FIGS. 4A, 4B, 4C, and 4D illustrate respective moments in time during execution of another quantum entanglement protocol in which a single quantum memory module of the quantum interconnection device is used in order to establish entanglement between two external quantum devices, according to some embodiments.

FIG. 5 is a flow diagram that illustrates execution of a given implementation of the quantum entanglement protocol, according to some embodiments.

FIG. 6 is a block diagram that illustrates an example computing device that may be used in at least some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as defined by the appended claims. It is to be understood that the disclosed embodiments are merely examples and other embodiments can take various and alternative forms. The drawings are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments.

As used throughout this application, the word “may” is used in a permissive sense (i.e., meaning having the potential to), rather than the mandatory sense (i.e., meaning must). Similarly, the words “include,” “including,” and “includes” mean including, but not limited to. When used in the claims, the term “or” is used as an inclusive or and not as an exclusive or. For example, the phrase “at least one of x, y, or z” means any one of x, y, and z, as well as any combination thereof. Furthermore, words such as “first,” “second,” “third,” etc. are meant to be used to distinguish a “first” element with respect to a “second” element, and so on, and should not be interpreted as limiting, but merely as a chosen naming convention for ease of discussion herein.

### DETAILED DESCRIPTION

The present disclosure relates to methods, apparatuses, and systems for executing a quantum entanglement protocol at a quantum interconnection device for distributed quantum entanglement between two or more external quantum devices.

As introduced above, the ability to scale computation capabilities of today's quantum computers risks reaching an upper limit due to current hardware limitations, such as due both to a number of physical qubits that can be made to be realistically and consistently operational within each quantum processing unit and to the ability to sufficiently correct and mitigate the directly correlated increase in error rates caused by the proximity and interaction of the increased number of physical qubits themselves.

The present disclosure overcomes these hardware limitations that are currently imposed onto quantum hardware manufacturers by enabling quantum processing units (QPUs) to be networked together via distributed quantum entanglement, such that the networked QPUs can be combined into commercially useful and modular quantum computing systems. By providing reliable methods for establishing quantum entanglement between given QPUs, or other quantum hardware devices, quantum computer manufacturers do not have to continue to try to scale the number of physical qubits within each QPU nearly as high, while simultaneously working against the competing interference problems that comes with trying to scale, in order to reach a level of fault tolerant quantum computing that is also applicable to real-world computation requirements.

Embodiments described herein pertain to a hardware architecture of a quantum interconnection device that is configured to receive various types of optical signals from respective external quantum devices, and subsequently perform heralded, quantum information storage operations to transfer quantum information to memory qubits within the quantum interconnection device. Various iterations of heralded Bell state measurements and/or local, deterministic operations are then performed, such that quantum entanglement is then established between the external quantum devices without any individual qubits of the respective external quantum devices having directly interacted with one another.

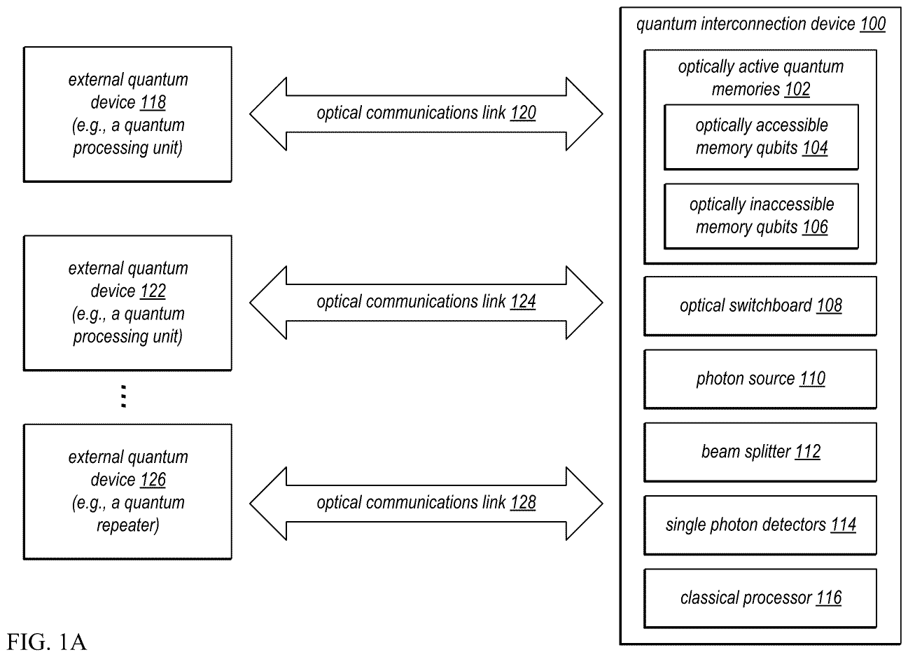

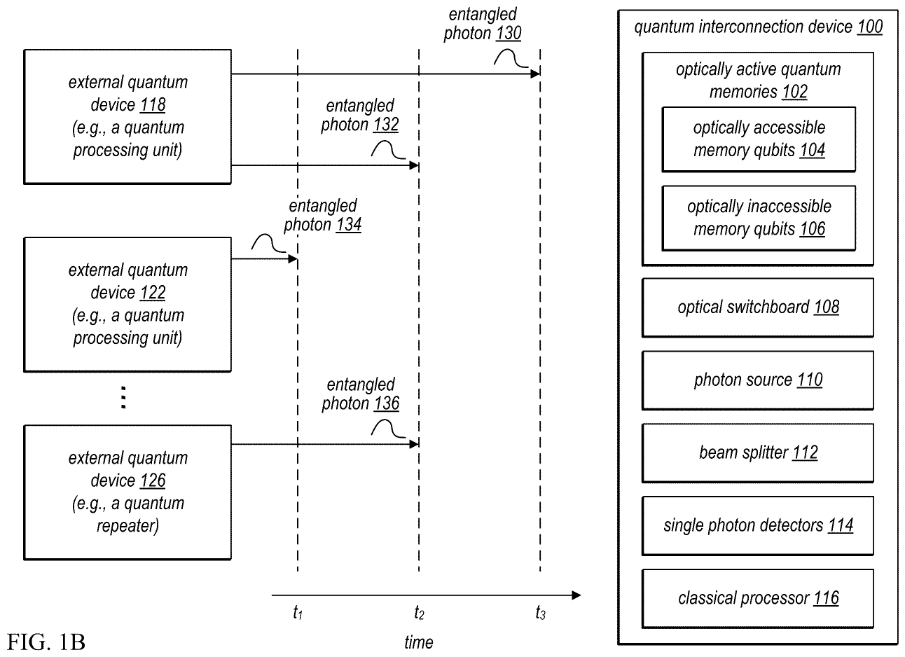

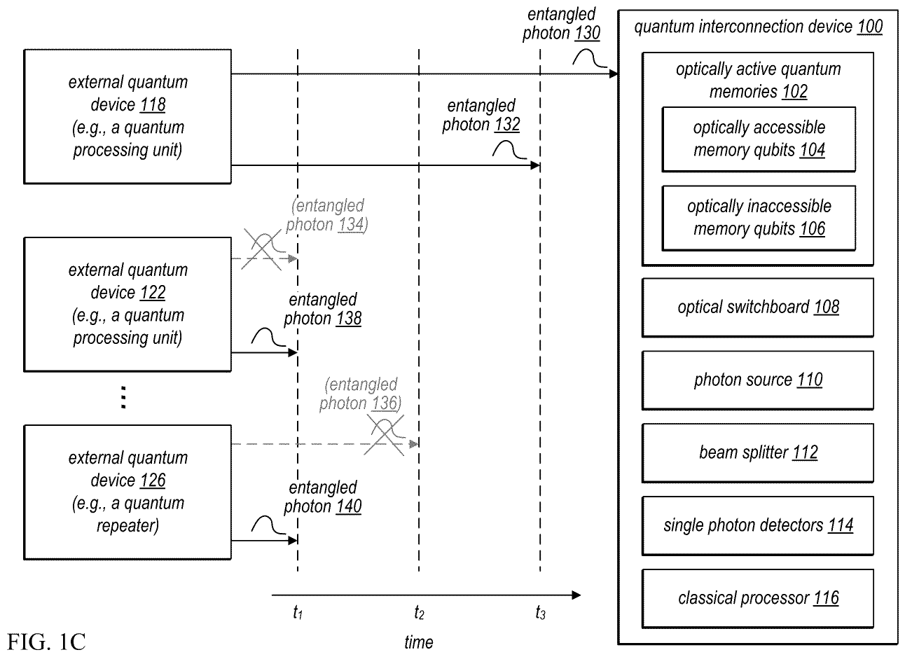

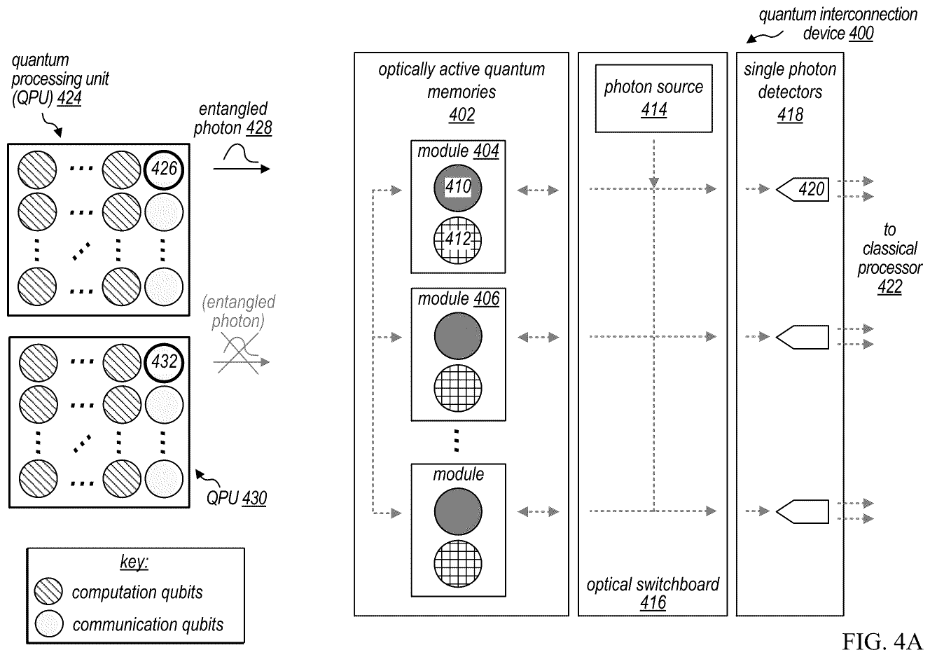

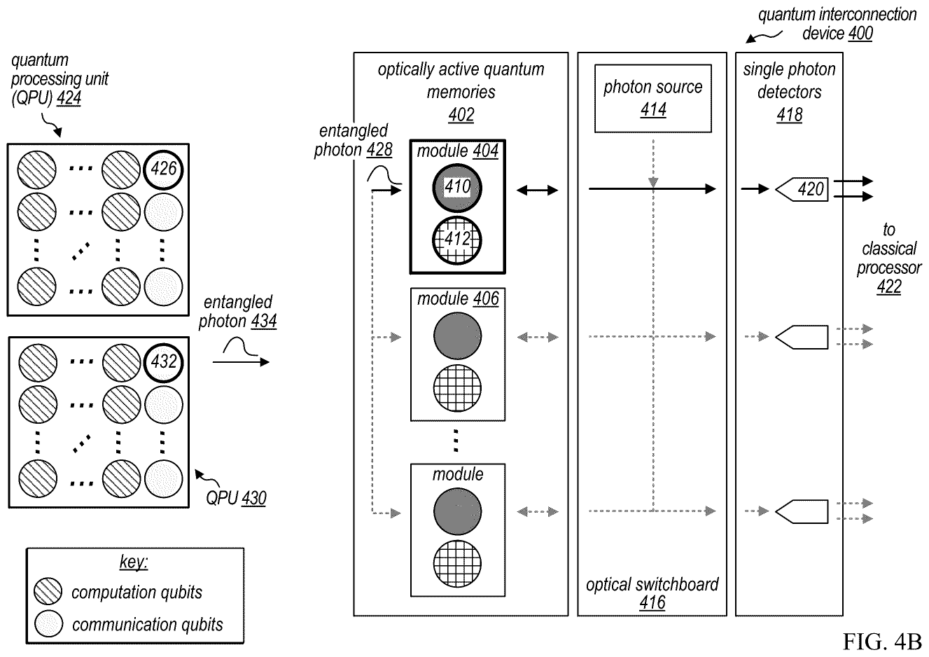

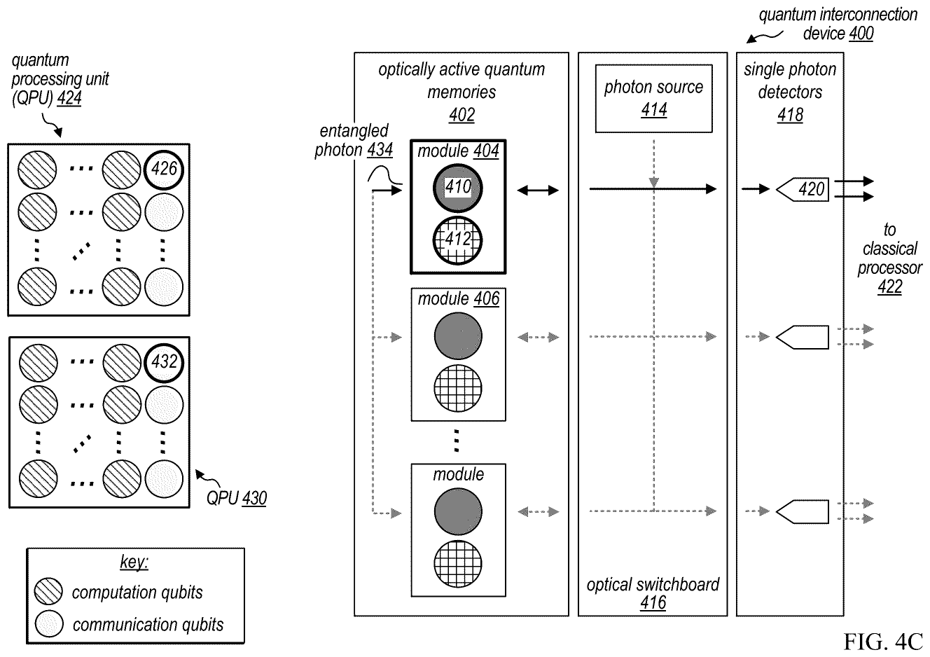

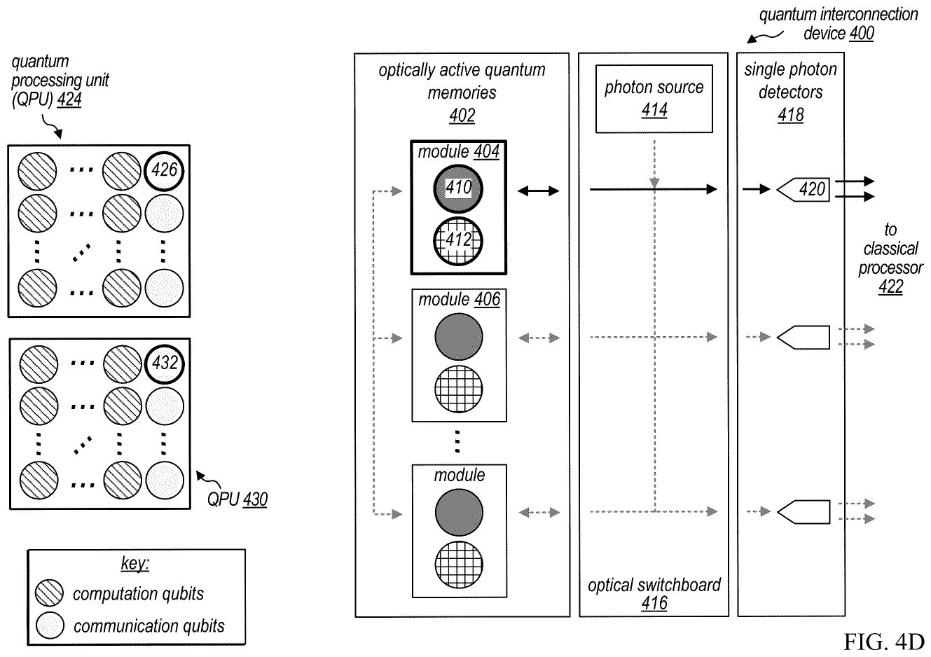

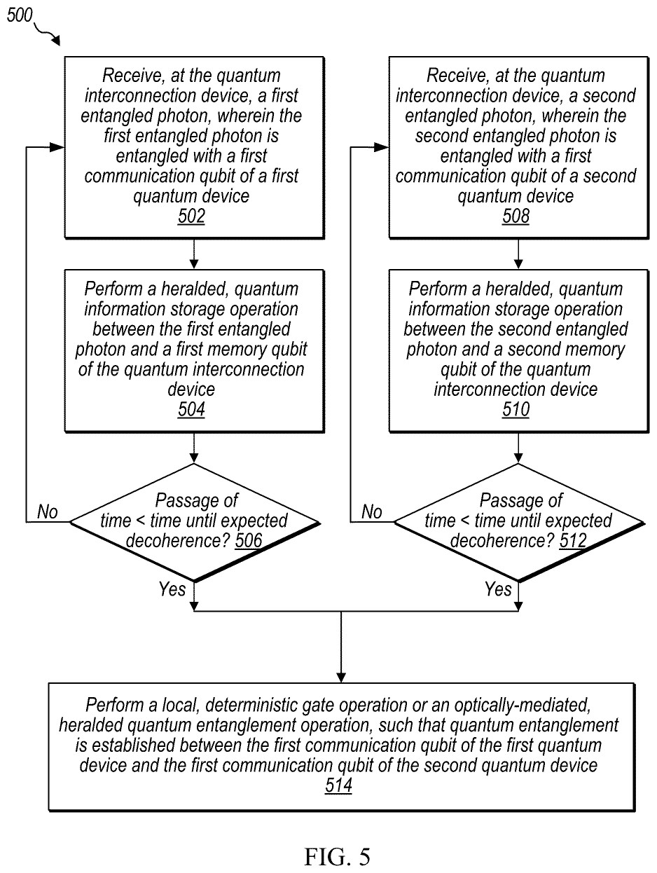

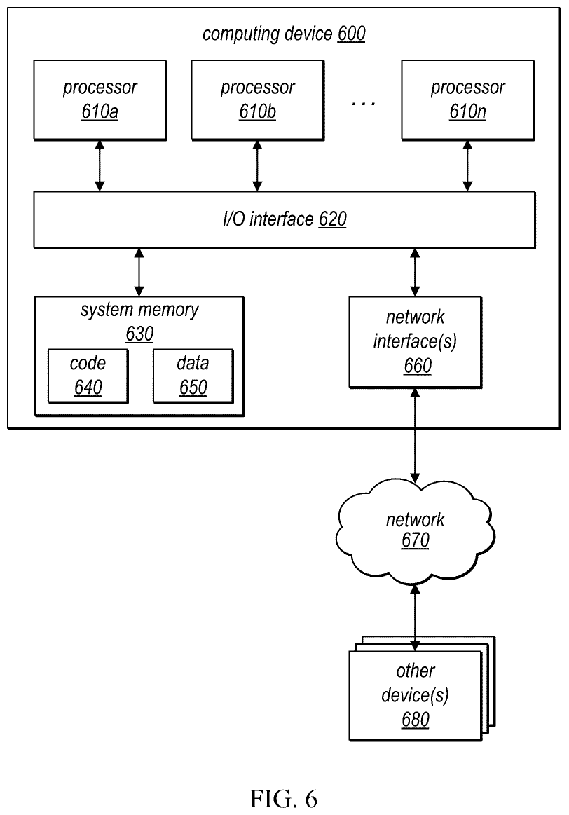

The present disclosure continues with examples of hardware configurations of quantum interconnection devices in FIGS. 1A-3. Then, the execution of various quantum entanglement protocols using those quantum interconnection devices is discussed with regard to FIGS. 4A-5. Finally, a description of an example computing system that is configured to perform various steps within the quantum entanglement protocols discussed herein is provided in FIG. 6.

Various examples are provided throughout the specification. A person having ordinary skill in the art should understand that the previous and following description of executing quantum entanglement protocols using quantum interconnection devices is not to be construed as limiting as to the implementation of said processes, devices, or portions thereof.

FIG. 1A illustrates a quantum interconnection device that is connected, via optical communication links, to various external quantum devices (e.g., QPUs, quantum repeaters, quantum sensors, etc.). FIGS. 1B and 1C then further illustrate respective moments in time during which the quantum interconnection device is configured to receive various optical signals, via those optical communication links, and subsequently begin executing a quantum entanglement protocol, according to some embodiments.

As shown in FIGS. 1A, 1B, and 1C, a quantum interconnection device 100 is configured to receive optical signals from one or more external quantum devices, such as external quantum devices 118, 122, and 126, and, upon reception of a given optical signal, initiate and/or continue execution of a given implementation of a quantum entanglement protocol. Quantum interconnection device 100 is configured to subsequently extend quantum entanglement from (1) between a first external quantum device and the quantum interconnection device 100 to (2) between the first external quantum device and one or more of the other external quantum devices.

Quantum interconnection device 100 may be configured to receive optical signals from one or more external quantum devices via optical fiber based connections of an optical fiber network, free-space and/or atmospheric communications links, or any other type of optical communications link that enables the movement of light from one physical location to another physical location. As illustrated in FIG. 1A, quantum interconnection device 100 may receive optical signals from external quantum device 118 via optical communications link 120, from external quantum device 122 via optical communications link 124, and from external quantum device 126 via optical communications link 128. As additionally described below, classical processor 116 may also be configured to send and receive classical communications from the external quantum devices (and/or their respective classical control devices) before, during, and after execution of the quantum entanglement protocol. See, for example, computing device 600 in FIG. 6, which is configured to communication with other devices 680 via network 670.

It should be understood that optical communications links 120, 124, and 128 are meant to be illustrative in nature, and that the respective ones of the external quantum devices may be connected to quantum interconnection device 100 via more than one optical communications links, according to some embodiments. Additionally, a given optical communications link may resemble one or more individual optical fiber connections, such that a given external quantum device may be configured to couple to a corresponding one or more of the optically accessible memory qubits 104 within the overall optically active quantum memories 102 of quantum interconnection device 100.

Moreover, quantum interconnection device 100 is configured to receive those optical signals in parallel, and asynchronously with respect to one another. As optical communications links 120, 124, and 128 may resemble lossy communication channels, for example, more than one external quantum device that is shown in FIG. 1A may be simultaneously attempting to send optical signals to quantum interconnection device 100. A given photon may be lost in transit along a given lossy communication channel, and therefore the corresponding external quantum device may continue to send and resend the optically-based information to quantum interconnection device 100 until an indication is sent from the classical processor 116 that the optically-based information has arrived at quantum interconnection device 100. This is additionally illustrated in FIGS. 1B and 1C.

FIGS. 1B and 1C illustrate this passage of time during which optical signals, such as the entangled photons shown in the figures, are in transit along the respective optical communications links. This is indicated using moments in time t₁, t₂, and t₃ along a time axis.

As shown in FIG. 1B, external quantum device 118 emitted entangled photon 130 at a moment in time that is earlier than entangled photon 132 (see time t₃ and time t₂, as illustrated in the figure). As such, entangled photon 130 will arrive at quantum interconnection device 100 earlier than entangled photon 132, if it is not lost along the corresponding lossy communication channel. In other examples, amount of time t₁ has passed since external quantum device 122 emitted entangled photon 134, and amount of time t₂ has passed since external quantum device 126 emitted entangled photon 136.

As shown in FIG. 1C, entangled photon 130 is now arriving at quantum interconnection device 100, and entangled photon 132 is still in transit along optical communications link 120. In addition, entangled photon 134 has been lost in transit along optical communications link 124, and also amount of time t₁ has passed since external quantum device 122 emitted an additional entangled photon 138. As introduced above, external quantum device 122 may be configured to continuously attempt to send entangled photons across the lossy communications channel until classical processor 116 has sent an indication that an entangled photon has arrived at quantum interconnection device 100 (see below examples of heralded quantum information storage operations). In another example illustrated in FIG. 1C, entangled photon 136 has been lost in transit along optical communications link 128, and also amount of time t₁ has passed since external quantum device 126 emitted an additional entangled photon 140.

As the given depiction of quantum interconnection device 100 in FIGS. 1B and 1C shows that it, at any moment in time, may receive optical signals from one or more of external quantum devices 118, 122, and 126, quantum interconnection device 100 is configured to have a correspondingly large amount of optically active quantum memories 102 initialized and at the ready, in order to execute one or more quantum entanglement protocols both in parallel with one another and wherein respective executions of the protocols might be currently performing different steps within the overall and corresponding protocol executions.

Asynchronous reception of optical signals is additionally described below with regards to quantum entanglement protocols, as heralded quantum information storage operations and lengths of time in which quantum information is stored in optically inaccessible memory qubits may occur either simultaneously or at different moments in time with respect to one another.

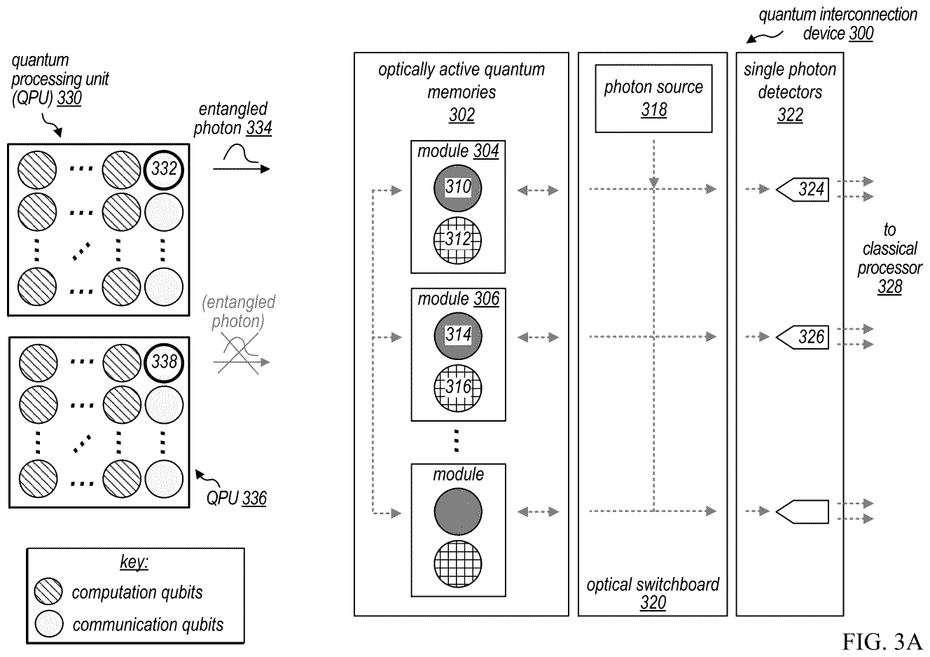

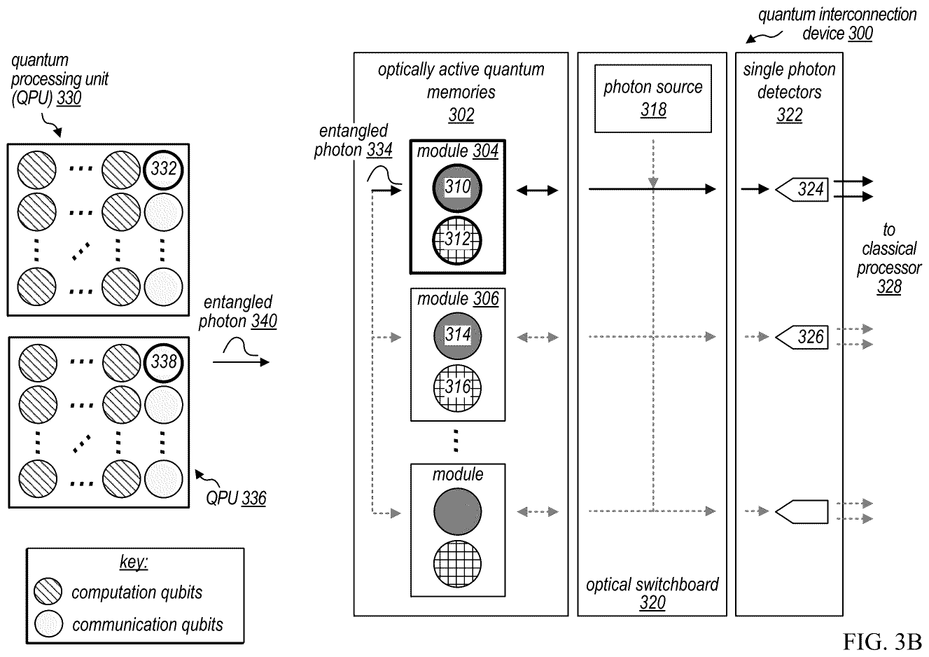

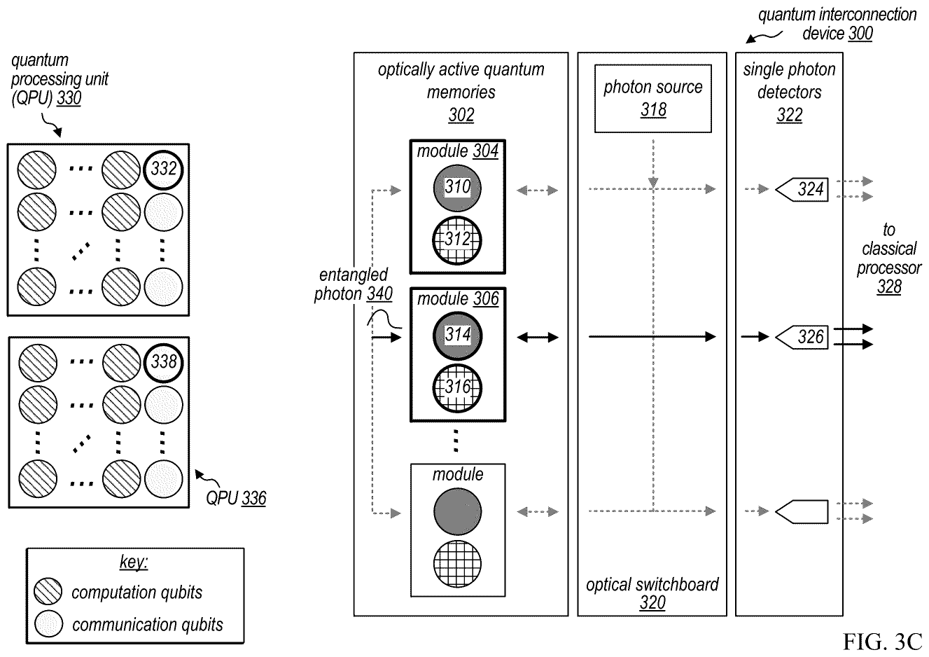

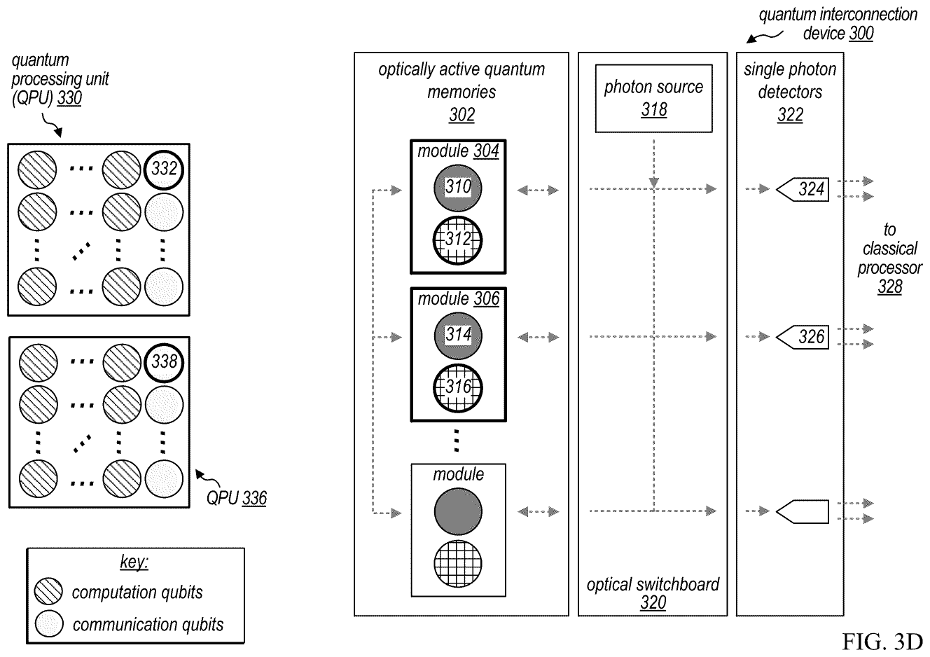

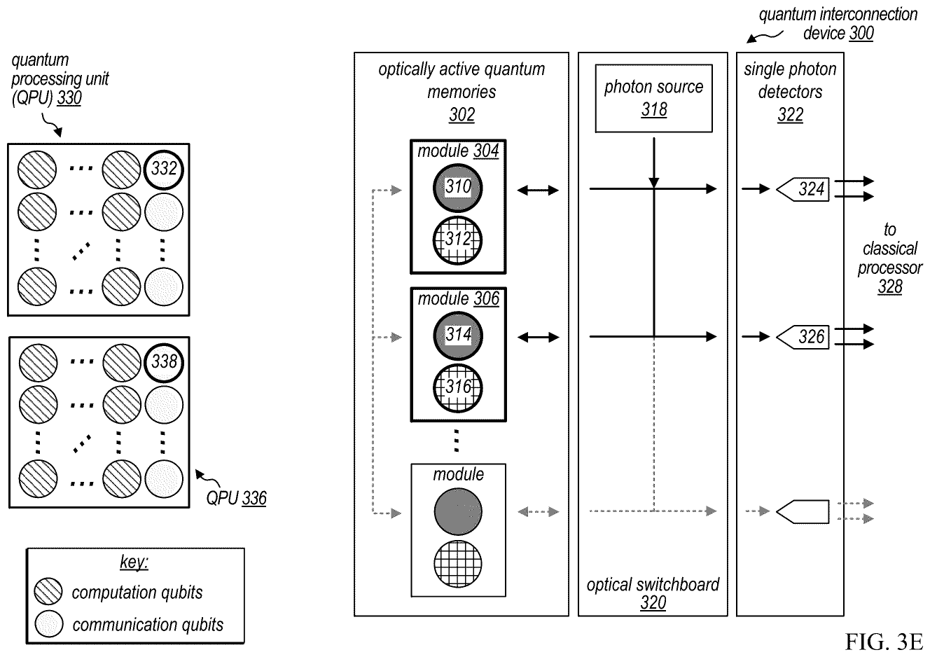

As used herein, external quantum devices, such as external quantum devices 118, 122, and 126, and QPUs 330, 336, 424, and 430 in FIGS. 3A-4D, are defined as devices that, at a minimum, are configured to emit optical signals. In embodiments shown in FIGS. 1A-1C, for example, external quantum device 118 is implemented as a first QPU and external quantum device 122 is implemented as a second QPU, while external quantum device 126 is implemented as a quantum repeater. Other examples of external quantum devices may include quantum sensors, single photon emitters, single photon detectors, or any combination therein.

The different implementations of external quantum devices that are connected to quantum interconnection device 100 via respective optical communications links may, in part, dictate the type of optical signal being transmitted to quantum interconnection device 100, which is also configured to receive the various types of optical signals. As such, depictions of “entangled photons” in FIGS. 1A-1C are meant to be illustrative in nature of an expected type of optical signal that may be emitted from a QPU or from a quantum repeater. However, other implementations of external quantum devices, such as quantum sensors, may emit other types of optical signals, and are therefore also meant to be included in the description of the present disclosure herein.

Moreover, the external quantum devices are “external” in that they are physically distinct and different from quantum interconnection device 100, and are connected to quantum interconnection device 100 via one or more optical communication links.

Quantum interconnection device 100 may be physically located proximate or at a distance from the one or more other external quantum devices. In a first example, external quantum devices 118 and 122 may both refer to respective QPUs of a larger modular quantum computing system. In such embodiments, quantum interconnection device 100 may then be configured to provide quantum entanglement between various qubits of QPU 118 and various other qubits of QPU 122 during execution of a logical quantum circuit or algorithm. As such, quantum interconnection device 100, quantum device 118, and quantum device 122 may be located at a same data center or other premises of a service provider of the modular quantum computing system. In a second example, quantum device 122 and quantum device 126 may each resemble quantum repeaters that are part of a larger quantum entanglement network that is configured to provide quantum key encryption services between customers of the service. In such embodiments, quantum interconnection device 100, quantum device 122, and quantum device 126 may be respectively located at different physical locations, sometimes at great physical distance, from one another.

The following paragraphs describe hardware components of the types of quantum interconnection devices that are encompassed within the present disclosure, along with various interactions between those hardware components. Examples of establishing, via execution of a quantum entanglement protocol at the quantum interconnection device, quantum entanglement between various other external quantum devices are additionally discussed with regard to FIGS. 3A-5 herein.

For ease of discussion within the following paragraphs, hardware components are discussed in an order in which the various hardware components interact with one another during a generalized flow of the quantum entanglement protocols described herein. In addition, transmission of entangled photon 130 from external quantum device 118 to quantum interconnection device is similarly used for ease of discussion. However, the various interactions between hardware components of quantum interconnection device 100 are not limited to entangled photon 130, and are instead meant to encompass hardware component interactions when any optical signals are being transmitted to quantum interconnection device 100.

Upon reception of an optical signal, such as entangled photon 130, a transducer may receive the optical signal and perform a frequency conversion operation in order to make the input optical signal compatible with optically active quantum memories 102. Depending upon a type of optical signal that is received, the frequency range of operation of the transmitted entangled photon 130 (e.g., several GHz to hundreds of THz) may be converted to within a different frequency range that is compatible for operation and interaction with optically active quantum memories 102. In some embodiments, a transducer of quantum interconnection module 100 may resemble a time-bin qubit encoding conversion module, or any other means for including wavelength or mode matching.

Optical switches within optical switchboard 108 are then configured to provide an optical pathway from an input optical port of quantum interconnection device 100 to an interfacing point of optically active quantum memories 102. The configuration of those various optical switches that then enable optical pathways is controlled by classical processor 116, and is additionally described below with regard to optical switchboards 218, 320, and 416.

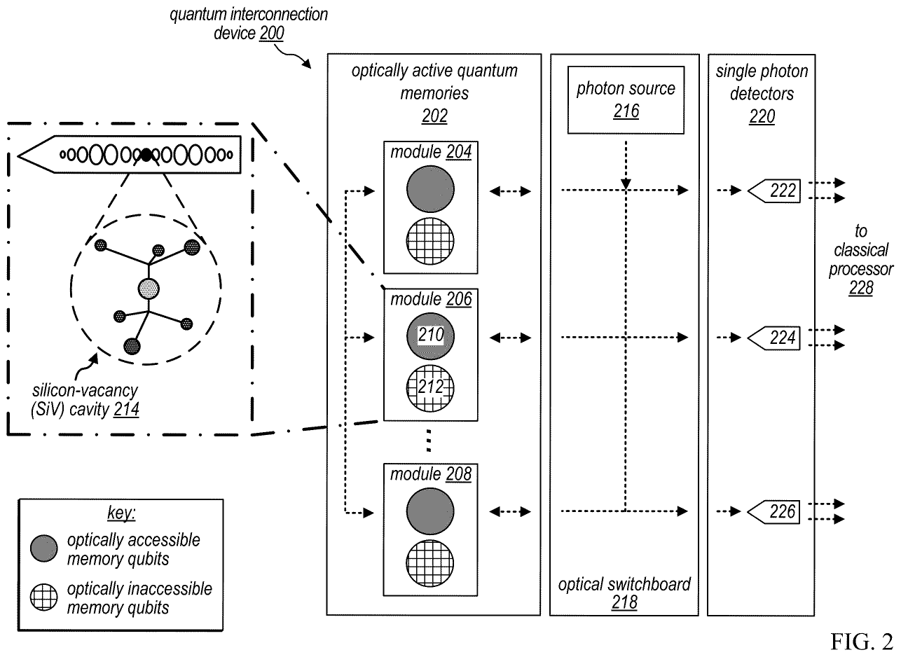

Once the frequency-compatible signal reaches optically active quantum memories 102, it is routed to an optically accessible qubit of optically accessible qubits 104. Illustrations in FIGS. 2-4D provide examples of how optically active quantum memories 102 may include multiple quantum memory modules which, in turn, include one or more optically accessible memory qubits and one or more optically inaccessible memory qubits.

As additionally defined below with regard to SiV cavity 214 of quantum memory module 206, both optically accessible and optically inaccessible memory qubits of optically active quantum memories 102 may be mapped to various physical components of a single quantum memory. In the example shown in FIG. 2, quantum memory module 206 is implemented using an SiV cavity. As such, a given optically accessible memory qubit of optically accessible memory qubits 104 is mapped to an electron of the SiV cavity, and a given optically inaccessible memory qubit of optically inaccessible memory qubits 106 is mapped to a silicon nucleus of the SiV cavity.

Optically accessible memory qubits 104 are defined herein as qubits that are configured to interact with incoming optical signals and with various other optical components within quantum interconnection device 100 via optical switchboard 108. Pertaining to the description herein, optically accessible memory qubits 104 may primarily be used during heralded quantum information storage operations, and any operations within an overall quantum entanglement protocol that pertain to reception of an entangled photon to quantum interconnection device 100 (e.g., from quantum device 118), to performance of local deterministic operations within a given module, to heralded Bell state measurements, and to any extension therein pertaining to multi-qubit measurements.

Optically inaccessible memory qubits 106 are defined herein as qubits that are configured for internal operations within a given quantum memory module of optically active quantum memories 102. Pertaining to the description herein, optically inaccessible memory qubits 106 may primarily be used for storage of quantum information, during heralded Bell state measurements, and any other quantum processing or computation (e.g., local operations between a given optically accessible memory qubit and a given optically inaccessible memory qubit within a given quantum memory module) that is performed during an overall quantum entanglement protocol.

Additional examples of photon-mediated, or optically-mediated, entanglement operations are discussed with regard to FIG. 3E herein.

Continuing with the description of optically accessible and inaccessible memory qubits 104 and 106, quantum interconnection device 100 is then configured to perform a heralded quantum information storage operation between the frequency-compatible version of entangled photon 130 and a given one of optically accessible memory qubits 104. Following performance of the heralded quantum information storage operation, quantum information is considered to be stored within a given optically inaccessible memory qubit of optically active quantum memories 102. Specifically, stored quantum information is defined herein as having stored quantum state amplitude information of the originally transmitted entangled photon 130 using a given memory qubit of optically active quantum memories 102.

Optically active quantum memories 102 are configured to store quantum information, and are thus also configured to interact with light, such that a photon in a superposition state may be transferred to on-device storage of quantum interconnection device 100. Once again, optically active quantum memories 102 may be implemented as SiV cavities, wherein a silicon vacancy is engineered into an overall diamond structure. In other implementations, however, other structures, such as nitrogen vacancies in diamond, trapped atoms, ensemble doped crystals, atomic vapors, silicon carbide emitters, single rare earth dopants, trapped ions, superconducting qubits, quantum dots in gallium arsenide, etc. may be used.

Optical switchboard 108 comprises optical switches that enable various optical pathways to be formed and/or blocked at different moments in time during execution of a quantum entanglement protocol. Optical switchboard 108 is configured to route light to and from optically active memory qubits of optically active quantum memories 102, and is configured to route light to single photon detectors 114 (e.g., during performance of a heralded Bell state measurement). Moreover, and during various photon-mediated operations and during heralded Bell state measurements, optical switchboard 108 is configured to route light from a photon source 110 to various ones of optically active quantum memories 102. In yet another example, upon receiving a heralding signal that indicates that a heralded quantum information storage operation has just been completed, classical processor 116 may cause a given optical pathway to be blocked that would have otherwise allowed entangled photons to keep arriving at the location of the corresponding quantum memory module.

Photon source 110 may be implemented as a single photon source, a single photon emitter, or a laser, and is configured for use during photon-mediated operations and during certain types of heralded Bell state measurements.

Quantum interconnection device 100 may include various other optical components, such as beam splitter 112, delay lines, etc.

Single photon detectors 114 are configured to output heralding signals and photon detections to classical processor 116 during various moments in time during an overall execution of a quantum entanglement protocol.

Quantum interconnection device 100 may also include various other hardware components that pertain to interfacing points between quantum interconnection device 100 and an optical fiber network, between quantum interconnection device 100 and various other control devices, etc. As such, quantum interconnection device 100 includes optical fiber ports and electrical ports that provide access points between optical fiber cables, control signal leads, electrical wires, electrical cables, etc. that located external to the quantum interconnection device, and to various components within the quantum interconnection device.

FIG. 2 additionally illustrates components of a quantum interconnection device, including a given implementation of memory qubits as being mapped to components of silicon-vacancy (SiV) cavities, according to some embodiments.

Continuing with the description of hardware components of quantum interconnection devices and their interactions with respect to one another, quantum interconnection device 200 depicts optically active quantum memories 202 as having at least three modular sets of quantum memory locations, wherein each of quantum memory modules 204, 206, and 208 include at least one optically accessible memory qubit and at least one optically inaccessible memory qubit. It should be understood that other embodiments of optically active quantum memories 202 may include more or less quantum memory modules than that which is illustrated in FIG. 2. Moreover, depending upon expected optical signal “traffic” levels between quantum interconnection device 200 and the various other external quantum devices it may receive optical signals from at any given time, a number of quantum memory modules within optically active quantum memories 202 may be configured such that a number of optically accessible memory qubits exceeds a number of possible communication qubits within the external quantum devices that quantum interconnection device 200 may be expected to maintain quantum entanglement with at any given time.

For example, quantum memory module 204 may be logically mapped by classical processor 228 for storing quantum information that is received from external quantum device 118, quantum memory module 206 may be logically mapped by classical processor 228 for storing quantum information that is received from external quantum device 122, and so on.

As additionally illustrated in FIG. 2, quantum memory module 206, and quantum memory modules 204 and 208 by extension, is shown to be implemented as an SiV cavity. SiV cavity 214 is patterned into a diamond photonic waveguide, such that the SiV region is surrounded by through-holes that function as mirrors, which momentarily trap incoming light before it is reflected or transmitted through and away from the SiV cavity. This allows for the optically accessible memory qubit within SiV cavity 214 to interact with an incoming entangled photon long enough for the heralded quantum information storage operation to be performed, wherein quantum information is transferred from the incoming entangled photon to the optically accessible memory qubit, in order to extend quantum entanglement.

Specifically, and as introduced above, optically accessible memory qubit 210 is mapped to an electron of SiV cavity 214, and optically inaccessible memory qubit 212 is mapped to a silicon nucleus of SiV cavity 214.

A specific charge state of SiV cavity 214 may vary according to a doping level of the diamond photonic waveguide that SiV cavity 214 is patterned into. For example, and continuing with the implementation described in the previous paragraph, a negatively charged SiV cavity, also written as an SiV⁻ cavity, enables optically accessible memory qubit 210 to be mapped to an electron of SiV⁻ cavity 214, and optically inaccessible memory qubit 212 to be mapped to the silicon nucleus of SiV⁻ cavity 214.

Moreover, the term optically accessible memory qubits, as used herein, is also defined by memory qubits which enable strong coupling between a photonic signal (e.g., a photon) that has been emitted from a photon source, such as photon source 216, and respective ones of the optically accessible memory qubits.

In some embodiments, quantum memory modules 204, 206, and 208 may be respectively patterned into a “host” material, such as the example in FIG. 2 that illustrates a silicon-vacancy-in-diamond structure. However, in other embodiments, quantum memory modules 204, 206, and 208 may resemble other nanophotonic cavities, such as a nitrogen-vacancy-in-diamond structure, or may resemble ring resonators, plasmonic cavities, Fabry Perot cavities, doped crystals, atomic vapors, silicon carbide emitters, single rare earth dopants, trapped ions, superconducting materials, quantum dots in gallium arsenide, defect centers in silicon or other semiconducting materials, etc.

As additionally illustrated in FIG. 2, various optical pathways are enabled (shown as dashed lines in the figure within the depictions of optically active quantum memories 202, optical switchboard 218, and single photon detectors module 220 respectively) using optical switches within an overall quantum interconnection device 200. An overall optical switchboard 218 may include various optical components, such as photon source 216, interferometers, lasers, single photon detectors module 220, microwave signal generators, and any other optical components that may be configured to assist in performance of photon-mediated operations. Optically-mediated operations may additionally refer to any local gate operations that are performed on or between memory qubits of a given quantum memory module, to any readout of a superposition state of said memory qubits, and to any initialization of said memory qubits into superposition states.

Moreover, and as shown in FIG. 2, optical switches of optical switchboard 218 are configured such that optical pathways between respective ones of quantum memory modules 204, 206, and 208 provide all-to-all connectivity between the modules for both optically-mediated operations and photon-mediated operations between respective ones of the memory qubits.

Single photon detectors 222, 224, and 226, which are collectively referred to herein as single photon detectors module 220, are configured to receive optical signals via optical pathways enabled by optical switchboard 218 and detect presence of photons. Those detection signals, also referred to herein as heralding signals, are then provided to classical processor 228 during various moments in time during execution of the quantum entanglement protocol (e.g., during heralded quantum information storage operations and heralded Bell state measurements).

FIGS. 3A, 3B, 3C, 3D, and 3E illustrate respective moments in time during execution of a quantum entanglement protocol in which multiple quantum memory modules of the quantum interconnection device are used in order to establish entanglement between two external quantum devices, according to some embodiments.

In the below description, a given implementation of the execution of a quantum entanglement protocol using quantum interconnection device 300 results in quantum entanglement being established between communication qubit 332 of QPU 330 and communication qubit 338 of QPU 336. It should be understood that the example embodiments shown in FIGS. 3A-3E are meant to be illustrative in nature, and that the implementation of quantum entanglement protocols using the hardware architecture of the quantum interconnection devices described herein may be extended to any number of other embodiments that apply the principles at least described in the following example flow of FIGS. 3A-3E.

Similarly to that which was described above with regard to quantum interconnection devices 100 and 200, quantum interconnection device 300 includes a set of quantum memory modules that are collectively referred to as optically active quantum memories 302. During execution of the quantum entanglement protocol, various optically-mediated and photon-mediated operations may be performed on or between respective ones of the memory qubits within optically active quantum memories 302, and various entangled photons may be routed along optical pathways that are enabled by optical switches of optical switchboard 320, including at least optical pathways that lead to single photon detectors 322.

In order to give context to the stages of quantum entanglement operations that are performed at quantum interconnection device 300 with respect to initial optical signals that are received from QPUs 330 and 336, the following paragraphs provide brief descriptions for such external quantum devices.

It may be assumed that, in particular embodiments shown in FIGS. 3A-3E, quantum interconnection device 300 is providing distributed quantum entanglement for two QPUs of a modular quantum computing system. In some embodiments, the QPUs may be owned by a third party, such that quantum interconnection device 300 is acting as a service provider to the third party.

In such cases, a given quantum circuit or algorithm may be executing across at least QPUs 330 and 336, in which one or more logical operations within the larger quantum algorithm requires teleportation of quantum information between the respective QPUs during at least one moment in time in the overall execution of the quantum algorithm. As such, QPUs 330 and 336 may be coupled at a physical distance to quantum interconnection device 300 by optical communications links, such that quantum interconnection device 300 can establish quantum entanglement between communication qubits of the respective QPUs.

In the description that follows, “communication” qubits refer to qubits located within the QPUs themselves, which have been logically designated for quantum entanglement operations. In contrast, “computation” qubits refer to qubits that are also located within the QPUs themselves, but which have been logically designated for single and/or multi-qubit gate operations (e.g., for direct execution of gates within the overall quantum algorithm). It should therefore be understood that, just prior to the moment in time shown in FIG. 3A, quantum entanglement has been established between some computation qubit and some communication qubit, and then quantum information has been transferred from the computation qubit to the communication qubit within the given QPU, in preparation for transmitting an entangled photon to quantum interconnection device 300.

Moreover, examples of QPUs, such as QPUs 330 and 336, are meant to be illustrative in nature, and the discussion herein is meant to encompass additional embodiments of QPUs with more or less computation and/or communication qubits than those shown in FIGS. 3A-3E, and/or QPUs with alternative physical qubit connectivity configurations.

Furthermore, quantum interconnection device 300 is agnostic to the type of physical qubits implemented within QPUs 330 and 336, since, as long as an optical signal of some type is emitted from the given QPU at the onset of a quantum entanglement protocol with quantum interconnection device 300, the physical implementation of the computation qubits within the QPUs themselves (e.g., superconducting, ion-trap, atom-based, etc.) does not impact the quantum entanglement protocol that follows.

Returning now to the illustrations in FIGS. 3A-3E, it is understood that classical processor 328 has received, just prior to the moment in time depicted in FIG. 3A, a request to establish quantum entanglement between QPU 330 and QPU 336 using quantum interconnection device 300. In some embodiments, classical processor 328 may also receive an indication that the quantum entanglement between QPU 330 and QPU 336 is to be established between communication qubit 332 and communication qubit 338, specifically. Classical processor 328 may receive additional information within the request, such as a number of external quantum devices that are to be provided the distributed quantum entanglement by quantum interconnection device 300 (e.g., two or more external quantum devices), etc.

In response to receiving the request, classical processor 328 causes the quantum entanglement protocol to be initiated. Upon initiation of the quantum entanglement protocol, classical processor 328 may also logically designate certain quantum memory modules within optically active quantum memories 302 that are to be used during execution of that particular quantum entanglement protocol. For example, quantum memory module 304 with optically accessible memory qubit 310 may be logically designated for receiving entangled photons along an optical communications link with QPU 330, while quantum memory module 306 with optically accessible memory qubit 314 may be logically designated for receiving entangled photons along another optical communications link with QPU 336.

At the moment in time depicted in FIG. 3A, communication qubit 332 is entangled with entangled photon 334, and a classical control device of QPU 330 causes entangled photon 334 to be transmitted to quantum interconnection device 300 via an optical communications link. As additionally illustrated in the figure, a classical control device of QPU 336 is also attempting to cause an entangled photon to be transmitted to quantum interconnection device 300, but the entangled photon is lost along the lossy communications channel.

At the moment in time depicted in FIG. 3B, entangled photon 334 is received at quantum interconnection device 300. As introduced above, entangled photon 334 may be routed, via optical pathways configured by optical switchboard 320, firstly through a transducer of quantum interconnection device 300, and then to optically accessible memory qubit 310 of quantum memory module 304. Optically accessible memory qubit 310 then interacts with entangled photon 334 during performance of a heralded quantum information storage operation, such that (1) the quantum information within entangled photon 334 is then transferred to optically accessible memory qubit 310, and (2) a heralding signal is propagated along an optical pathway (as denoted by the solid black optical pathway in FIG. 3B), through single photon detector 324, to classical processor 328. In the description that follows for FIGS. 3A-3E, this particular heralding signal is referred to as a first heralding signal of the quantum entanglement protocol.

At the moment of successful transfer of quantum information to optically accessible memory qubit 310, quantum entanglement is thus extended to between communication qubit 332 and optically accessible memory qubit 310.

Furthermore, from the moment that classical processor 328 receives the first heralding signal that heralds success of the quantum information storage operation, classical processor 328 is configured to then begin monitoring a passage of time, starting from the moment the first heralding signal was received. Memory qubits have an expected coherence time, after which point it may be assumed that the memory qubit is at risk of decoherence. Thus, classical processor 324 monitors the passage of time during which quantum information is being stored within quantum memory module 304 while awaiting successful transfer of quantum information into other memory qubit(s) that pertain to the particular quantum entanglement protocol.

In particular embodiments shown in the FIG. 3A-3E series, a local gate operation between optically accessible memory qubit 310 and optically inaccessible memory qubit 312 is also illustrated as being performed in FIG. 3B. This local gate operation transfers the quantum information within optically accessible memory qubit 310 to optically inaccessible memory qubit 312 for longer term storage. This may be particularly useful during execution of the quantum entanglement protocol since the second entangled photon, coming from QPU 336, has not yet arrived at quantum interconnection device 300 at the moment in time depicted in FIG. 3B.

Also at the moment in time depicted in FIG. 3B, the classical control device of QPU 330 has reattempted to transmit an entangled photon to quantum interconnection device 300. As shown in the figure, communication qubit 338 is entangled with entangled photon 340, and the classical control device of QPU 330 has caused entangled photon 340 to be transmitted to quantum interconnection device 300 via an optical communications link.

FIGS. 3A and 3B additionally illustrate that entangled photons 334 and 340 may be received at quantum interconnection device 300 at different times. Asynchronous reception of those entangled photons means that optically inaccessible memory qubit 312 will continue to store the quantum information received from QPU 330 for a given length of time before either (1) classical processor 328 receives the second heralding signal that causes it to then initiate heralded Bell state measurements between the two memory qubits in the form of an optically-mediated, heralded quantum entanglement operation between the two quantum memory modules, or (2) optically inaccessible memory qubit 312 passes the threshold after which it is assumed to have succumbed to decoherence.

At the moment in time depicted in FIG. 3C, entangled photon 340 is received at quantum interconnection device 300. As introduced above, entangled photon 340 may be routed, via optical pathways configured by optical switchboard 320, firstly through a transducer of quantum interconnection device 300, and then to optically accessible memory qubit 314 of quantum memory module 306. Optically accessible memory qubit 314 then interacts with entangled photon 340 during performance of a heralded quantum information storage operation, such that (1) the quantum information within entangled photon 340 is then transferred to optically accessible memory qubit 314, and (2) a heralding signal is propagated along an optical pathway (as denoted by the solid black optical pathway in FIG. 3C), through single photon detector 326, to classical processor 328. In the description that follows for FIGS. 3A-3E, this particular heralding signal is referred to as a second heralding signal of the quantum entanglement protocol.

At the moment of successful transfer of quantum information to optically accessible memory qubit 314, quantum entanglement is thus extended to between communication qubit 338 and optically accessible memory qubit 314.

In particular embodiments shown in the FIG. 3A-3E series, a local gate operation between optically accessible memory qubit 314 and optically inaccessible memory qubit 316 is also illustrated as being performed in FIG. 3C. This local gate operation transfers the quantum information within optically accessible memory qubit 314 to optically inaccessible memory qubit 316 for longer term storage.

Also at the moment in time depicted in FIG. 3C, optically inaccessible memory qubit 312 continues to store the quantum information received from QPU 330.

As additionally illustrated by FIG. 3D, the second heralding signal heralds success of the other heralded quantum information storage operation. As, in the particular embodiments shown in FIGS. 3A-3E, the second heralding signal marks the successful reception and storage of the quantum information from both communication qubit 332 and communication qubit 338, classical processor 328 causes the next stage of the quantum entanglement protocol to begin.

It may be assumed that prior to causing the next stage of the quantum entanglement protocol to begin, classical processor 328 is configured to positively determine that a passage of time for coherence (e.g., the passage of time since optically accessible memory qubit 310 began storing the quantum information) is less than the threshold amount of time until expected decoherence of optically accessible memory qubit 310 (and of optically inaccessible memory qubit 312, in the particular embodiments of FIGS. 3A-3E), and thus the quantum entanglement protocol can continue. If the passage of time was greater than the threshold amount of time until expected decoherence upon reception of the second heralding signal pertaining to the heralded quantum information storage operation with optically accessible memory qubit 314, classical processor 328 would have restarted the quantum entanglement protocol (e.g., begin again at the moment in time depicted in FIG. 3A).

As depicted in FIG. 3E, an optically-mediated, heralded, quantum entanglement operation is then performed between quantum memory modules 304 and 306. This operation includes two sub-operations. In a first sub-operation, classical processor 328 causes quantum entanglement generation to occur between optically accessible memory qubits 310 and 314 by causing a photonic signal (e.g., a photon or laser pulse) to be emitted from photon source 318. The photonic signal is provided along optical pathways between photon source 318, optically accessible memory qubit 310, and optically accessible memory qubit 314, as indicated by the black solid lines in the figure. In a second sub-operation, local gate operations are then performed between optically accessible memory qubit 310 and optically inaccessible memory qubit 312, and between optically accessible memory qubit 314 and optically inaccessible memory qubit 316, respectively. Collectively, these two sub-operations define the optically-mediated, heralded, quantum entanglement operation that results in a deterministic Bell state measurement that is measured out via single photon detectors 324 and 326. The results are then provided to classical processor 328. This is also defined herein as a third heralding signal of the overall quantum entanglement protocol depicted in FIGS. 3A-3E.

The reception of the third heralding signal marks the moment in time at which point quantum entanglement has been established between communication qubit 332 of QPU 330 and communication qubit 338 of QPU 336. From the moment in time at which the first entangled photon (e.g., entangled photon 334) successfully transfers quantum information to the first memory qubit (e.g., optically accessible memory qubit 310) until the moment that the optically-mediated, heralded, quantum entanglement operation is heralded (e.g., FIG. 3E), quantum interconnection device 300 acts as an intermediary, providing quantum entanglement between one or more communication qubits of one or more external quantum devices and at least one memory qubit of the quantum interconnection device 300 itself.

However, from the moment in time at which the third heralding signal is received at classical processor 328, distributed quantum entanglement is established between communication qubit 332 and communication qubit 338, thus terminating the quantum entanglement protocol.

Moreover, quantum interconnection device 300 thus establishes the distributed quantum entanglement between communication qubits of external quantum devices that have never directly interacted with one another in order to become entangled.

FIGS. 4A, 4B, 4C, and 4D illustrate respective moments in time during execution of another quantum entanglement protocol in which a single quantum memory module of the quantum interconnection device is used in order to establish entanglement between two external quantum devices, according to some embodiments.

The description and context provided above with regard to the hardware architecture of QPUs 330 and 336 may additionally be used to describe QPUs 424 and 430 throughout FIGS. 4A-4D.

It may be assumed that, in particular embodiments shown in FIGS. 4A-4D, quantum interconnection device 400 is providing distributed quantum entanglement for two QPUs of a modular quantum computing system. In some embodiments, the QPUs may be owned by a third party, such that quantum interconnection device 400 is acting as a service provider to the third party.

It is also understood that classical processor 422 has received, just prior to the moment in time depicted in FIG. 4A, a request to establish quantum entanglement between QPU 424 and QPU 430 using quantum interconnection device 400. In some embodiments, classical processor 422 may also receive an indication that the quantum entanglement between QPU 424 and QPU 430 is to be established between communication qubit 426 and communication qubit 432, specifically. Classical processor 422 may receive additional information within the request, such as a number of external quantum devices that are to be provided the distributed quantum entanglement by quantum interconnection device 400 (e.g., two or more external quantum devices), etc.

In response to receiving the request, classical processor 422 causes the quantum entanglement protocol to be initiated. Upon initiation of the quantum entanglement protocol, classical processor 422 may also logically designate certain quantum memory modules within optically active quantum memories 402 that are to be used during execution of that particular quantum entanglement protocol. For example, quantum memory module 404 with optically accessible memory qubit 410 may be logically designated for receiving entangled photons along an optical communications link with QPU 424, and along another optical communications link with QPU 430.

At the moment in time depicted in FIG. 4A, communication qubit 426 is entangled with entangled photon 428, and a classical control device of QPU 424 causes entangled photon 428 to be transmitted to quantum interconnection device 400 via an optical communications link. As additionally illustrated in the figure, a classical control device of QPU 430 is also attempting to cause an entangled photon to be transmitted to quantum interconnection device 400, but the entangled photon is lost along the lossy communications channel.

At the moment in time depicted in FIG. 4B, entangled photon 428 is received at quantum interconnection device 400. As introduced above, entangled photon 428 may be routed, via optical pathways configured by optical switchboard 416, firstly through a transducer of quantum interconnection device 400, and then to optically accessible memory qubit 410 of quantum memory module 404. Optically accessible memory qubit 410 then interacts with entangled photon 428 during performance of a heralded quantum information storage operation, such that (1) the quantum information within entangled photon 428 is then transferred to optically accessible memory qubit 410, and (2) a heralding signal is propagated along an optical pathway (as denoted by the solid black optical pathway in FIG. 4B), through single photon detector 420, to classical processor 422. In the description that follows for FIGS. 4A-4D, this particular heralding signal is referred to as a first heralding signal of the quantum entanglement protocol.

At the moment of successful transfer of quantum information to optically accessible memory qubit 410, quantum entanglement is thus extended to between communication qubit 426 and optically accessible memory qubit 410.

Furthermore, from the moment that classical processor 422 receives the first heralding signal that heralds success of the quantum information storage operation, classical processor 422 is configured to then begin monitoring a passage of time, starting from the moment the first heralding signal was received. Classical processor 422 monitors that passage of time during which quantum information is being stored within quantum memory module 404 while awaiting successful transfer of quantum information from QPU 430, and that pertain to the particular quantum entanglement protocol.

In particular embodiments shown in the FIG. 4A-4D series, a local gate operation between optically accessible memory qubit 410 and optically inaccessible memory qubit 412 is also illustrated as being performed in FIG. 4B. This local gate operation transfers the quantum information within optically accessible memory qubit 410 to optically inaccessible memory qubit 412 for longer term storage. This may be particularly useful during execution of the quantum entanglement protocol since the second entangled photon, coming from QPU 430, has not yet arrived at quantum interconnection device 400 at the moment in time depicted in FIG. 4B, but is still due to be provided to optically accessible memory qubit 410. Thus, the quantum information pertaining to QPU 424 is transferred to optically inaccessible memory qubit 412 in preparation for receiving additional quantum information from QPU 430 to the same quantum memory module 404.

Also at the moment in time depicted in FIG. 4B, the classical control device of QPU 430 has reattempted to transmit an entangled photon to quantum interconnection device 400. As shown in the figure, communication qubit 432 is entangled with entangled photon 434, and the classical control device of QPU 430 has caused entangled photon 434 to be transmitted to quantum interconnection device 400 via an optical communications link.

At the moment in time depicted in FIG. 4C, entangled photon 434 is received at quantum interconnection device 400. As introduced above, entangled photon 434 may be routed, via optical pathways configured by optical switchboard 416, firstly through a transducer of quantum interconnection device 400, and then to optically accessible memory qubit 410 of quantum memory module 404. Optically accessible memory qubit 410 then interacts with entangled photon 434 during performance of a heralded quantum information storage operation, such that (1) the quantum information within entangled photon 434 is then transferred to optically accessible memory qubit 410, and (2) a heralding signal is propagated along an optical pathway (as denoted by the solid black optical pathway in FIG. 4C), through single photon detector 420, to classical processor 422. In the description that follows for FIGS. 4A-4D, this particular heralding signal is referred to as a second heralding signal of the quantum entanglement protocol.

At the moment of successful transfer of quantum information to optically accessible memory qubit 410, quantum entanglement is thus extended to between communication qubit 432 and optically accessible memory qubit 410.

Also at the moment in time depicted in FIG. 4C, optically inaccessible memory qubit 412 continues to store the quantum information received from QPU 424.

As additionally illustrated by FIG. 4C, the second heralding signal heralds success of the other heralded quantum information storage operation. As, in the particular embodiments shown in FIGS. 4A-4D, the second heralding signal marks the successful reception and storage of the quantum information from both communication qubit 426 and communication qubit 432, classical processor 422 causes the next stage of the quantum entanglement protocol to begin.

It may be assumed that prior to causing the next stage of the quantum entanglement protocol to begin, classical processor 422 is configured to positively determine that a passage of time for coherence is less than the threshold amount of time until expected decoherence of the respective memory qubits, and thus the quantum entanglement protocol can continue. If the passage of time was greater than the threshold amount of time until expected decoherence upon reception of the second heralding signal, classical processor 422 would have restarted the quantum entanglement protocol (e.g., begin again at the moment in time depicted in FIG. 4A).

As depicted in FIG. 4D, a local, deterministic gate operation between optically accessible memory qubit 410 and optically inaccessible memory qubit 412 is performed. Results of the operation are measured out through single photon detector 420, which then provides the resulting signal to classical processor 422.

The reception of the result of the local, deterministic gate operation at classical processor 422 marks the moment in time at which point quantum entanglement has been established between communication qubit 426 of QPU 424 and communication qubit 432 of QPU 430. From the moment in time at which the first entangled photon (e.g., entangled photon 428) successfully transfers quantum information to the first memory qubit (e.g., optically accessible memory qubit 410) until the moment that the local, deterministic gate operation is successfully performed (e.g., FIG. 4D), quantum interconnection device 400 acts as an intermediary, providing quantum entanglement between one or more communication qubits of one or more external quantum devices and at least one memory qubit of the quantum interconnection device 400 itself.

Afterwards, however, distributed quantum entanglement is established between communication qubit 426 and communication qubit 432, thus terminating the quantum entanglement protocol.

Moreover, quantum interconnection device 400 thus establishes the distributed quantum entanglement between communication qubits of external quantum devices that have never directly interacted with one another in order to become entangled.

The quantum entanglement protocol that establishes distributed quantum entanglement between two external quantum devices using a single quantum memory module (e.g., FIGS. 4A-4D) may be implemented by means of a spin-spin interaction within a same SiV cavity. The quantum entanglement protocol that establishes distributed quantum entanglement between two external quantum devices using multiple quantum memory modules (e.g., FIGS. 3A-3E) may be implemented by means of photon-mediated interactions, also referred to herein as optically-mediated interactions, between respective SiV cavities. Combinations of such implementations may be extended, using multi-qubit measurements that are performed within the quantum interconnection device, to providing distributed quantum entanglement across three or more external quantum memory devices, according to some embodiments.

FIG. 5 is a flow diagram that illustrates execution of a given implementation of the quantum entanglement protocol, according to some embodiments.

In some embodiments, process 500 may be described using any of the above descriptions pertaining to FIGS. 1A-4D . In general, and as shown in blocks 502-514 in FIG. 5, the quantum entanglement protocols described herein may be subdivided into three stages. In a first quantum entanglement generation stage, an optical signal (e.g., an entangled photon) is received at the quantum interconnection device from some external quantum device, and a heralded quantum information storage operation is performed between the entangled photon and a memory qubit of the optically active quantum memories. If the performance of the storage operation is successful, a second, storage stage continues, wherein the memory qubit stores the quantum information that was transferred from the entangled photon. The storage stage continues until all heralding signals from respective heralded, quantum information storage operations for that particular implementation of the protocol have been performed. Then, a third, entanglement swapping stage begins, wherein quantum entanglement is established between the two or more external quantum devices that pertain to that particular implementation of the protocol.

Process 500 illustrates these three stages of the overall quantum entanglement protocol.

Blocks 506 and 512 illustrate a monitoring that the classical processor performs. For example, block 506 refers to a tracking that the classical processor cycles through wherein it marks the moment in time at which it has received the first heralding signal and the time that has passed since that event. As the first memory qubit has a finite lifetime before it may be expected to succumb to decoherence, the classical processor is configured to monitor for this threshold point. If the passage of time is still less than the expected decoherence threshold, then the classical processor continues to wait until it receives the second heralding signal. A similar monitoring cycle is shown in block 512 for other examples in which the second entangled photon in block 508 is received before the first entangled photon in block 502.

It should be understood that the sub-process that is illustrated by blocks 502, 504, and 506 may occur independently from the other sub-process that is illustrated by blocks 508, 510, and 512 (e.g., in embodiments in which a given quantum entanglement protocol utilizes multiple quantum memory modules, such as that which is described with regards to FIGS. 3A-3E herein). As the quantum interconnection device is configured to receive entangled photons asynchronously with respect to one another, the respective quantum entanglement generation and storage stages occur, repeat, restart, and/or otherwise progress independently until a moment in time at which the classical processor has received all heralding signals that herald completion of the corresponding number of heralded, quantum information storage operations.

In particular embodiments shown in FIG. 5, this storage stage of the quantum entanglement protocol continues until each of the required heralding signals, namely the first and second heralding signals in this case, is received by the classical processor. For other embodiments in which more than two memory qubits are required to interact with corresponding entangled photons during the quantum entanglement generation stage, then dynamical decoupling sequences, auxiliary quantum memories, and/or several rounds entanglement purification may be performed and/or utilized.

Returning now to the illustrations shown in FIG. 5, at the moment in time at which point the classical processor has received the second heralding signal, the classical processor confirms that both respective passages of time since receiving the respective first and second heralding signals are not greater than a time until expected decoherence of the first and the second memory qubits.

If the time that has progressed since herald detection is less than a predefined fraction of the coherence time (e.g., corresponding to an allowable level of infidelity in the overall operation) for each of the first and the second memory qubits, then the quantum entanglement protocol proceeds to the entanglement swapping stage.

Depending upon how much time has passed during the quantum entanglement generation stage and/or storage stage, the classical processor may be configured to provide instructions for means of storing the quantum information beyond the expected coherence time of the optically accessible memory qubit(s). In such cases, the quantum interconnection device may be configured to perform dynamical decoupling sequences to extend the lifetime of the stored quantum information. In yet other embodiments, optically active quantum memories within the quantum interconnection device may include optically inaccessible memory qubits which can be used to store the quantum information. A given optically inaccessible memory qubit may be coupled to a given optically accessible memory qubit that is currently storing the quantum information in order to transfer the quantum information to the optically inaccessible memory qubit using mechanical, magnetic, or other short-range interactions that are configured to occur within the quantum interconnection device. As such an optically inaccessible memory qubit (e.g., a silicon nucleus in embodiments in which a given quantum memory module is an SiV cavity) may have a longer coherence time than the optically accessible memory qubits (e.g., electrons, in embodiments in which the given quantum memory module is an SiV cavity), the quantum information may be stored past the expected moment of decoherence of the optically accessible memory qubits.

In yet other embodiments, a fidelity of the stored quantum information may be increased by using entanglement purification techniques to enhance total process fidelity. In this case, entanglement purification techniques can be used to enhance total process fidelity. Entanglement purification enables multiple low fidelity entangled pairs to be converted into a single higher fidelity entangled pair. As such, entanglement pumping may be applied.

Returning now to the illustrations shown in FIG. 5, block 514 marks the beginning of the entanglement swapping stage of the quantum entanglement protocol. Block 514 may refer to either description corresponding to FIG. 3E or to FIG. 4D, depending upon a number of quantum memory modules are being applied to the given quantum entanglement protocol depicted in FIG. 5. Block 514 thus refers to the performance of a local, deterministic gate operation or to an optically-mediated, heralded quantum entanglement operation. The result of block 514 is that the share of the quantum entanglement stored on the optically active quantum memories is eliminated, resulting in quantum entanglement purely between the first and the second communication qubits, which are located within the respective first and second quantum devices.

Process 500 may be extended to various combinations with regards to a number of external quantum devices that the quantum interconnection device is establishing distributed quantum entanglement for. A rate at which the quantum entanglement protocol is executed may also be fixed such that quantum entanglement is established while also enabling computation and error correction between the multiple QPUs themselves. This may also depend upon the type of qubit technology being used within the QPUs. From the perspective of the quantum interconnection device, the classical processor is configured to operate the quantum entanglement protocol on a schedule that is synchronized to the clock cycle of the quantum computing hardware.

Moreover, FIG. 5 depicts implementations of the quantum entanglement protocol being used to establish quantum entanglement for modular quantum computing systems. However, other implementations of process 500 may be applied to quantum computers with an external communication or sensing network, thus enabling the quantum computers to be accessed remotely or securely through the application of blind quantum computing. In yet other implementations of process 500, such quantum entanglement protocols enable a central quantum computer to perform coherent quantum computations on data provided by a network of quantum sensors, such as for long baseline interferometry.

FIG. 6 is a block diagram illustrating an example computing device that may be used in at least some embodiments.

FIG. 6 illustrates such a general-purpose computing device 600 as may be used in any of the embodiments described herein. In the illustrated embodiment, computing device 600 includes one or more processors 610 coupled to a system memory 630 (which may comprise both non-volatile and volatile memory modules) via an input/output (I/O) interface 620. Computing device 600 further includes a network interface 660 coupled to I/O interface 620.

In various embodiments, computing device 600 may be a uniprocessor system including one processor 610, or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x86, PowerPC, SPARC, or MIPS ISAs, or any other suitable ISA. In multiprocessor systems, each of processors 610 may commonly, but not necessarily, implement the same ISA. In some implementations, graphics processing units (GPUs) may be used instead of, or in addition to, conventional processors.

System memory 630 may be configured to store instructions and data accessible by processor(s) 610. In at least some embodiments, the system memory 630 may comprise both volatile and non-volatile portions; in other embodiments, only volatile memory may be used. In various embodiments, the volatile portion of system memory 630 may be implemented using any suitable memory technology, such as static random-access memory (SRAM), synchronous dynamic RAM or any other type of memory. For the non-volatile portion of system memory (which may comprise one or more NVDIMMs, for example), in some embodiments flash-based memory devices, including NAND-flash devices, may be used. In at least some embodiments, the non-volatile portion of the system memory may include a power source, such as a supercapacitor or other power storage device (e.g., a battery). In various embodiments, memristor based resistive random-access memory (ReRAM), three-dimensional NAND technologies, Ferroelectric RAM, magnetoresistive RAM (MRAM), or any of various types of phase change memory (PCM) may be used at least for the non-volatile portion of system memory. In the illustrated embodiment, program instructions and data implementing one or more desired functions, such as those methods, techniques, and data described above, are shown stored within system memory 630 as code 640 and data 650.

In some embodiments, I/O interface 620 may be configured to coordinate I/O traffic between processor 610, system memory 630, and any peripheral devices in the device, including network interface 660 or other peripheral interfaces such as various types of persistent and/or volatile storage devices. In some embodiments, I/O interface 620 may perform any necessary protocol, timing or other data transformations to convert data signals from one component (e.g., system memory 630) into a format suitable for use by another component (e.g., processor 610). In some embodiments, I/O interface 620 may include support for devices attached through various types of peripheral buses, such as a variant of the Peripheral Component Interconnect (PCI) bus standard or the Universal Serial Bus (USB) standard, for example. In some embodiments, the function of I/O interface 620 may be split into two or more separate components, such as a north bridge and a south bridge, for example. Also, in some embodiments some or all of the functionality of I/O interface 620, such as an interface to system memory 630, may be incorporated directly into processor 610.

Network interface 660 may be configured to allow data to be exchanged between computing device 600 and other devices 680 attached to a network or networks 670, such as other computer systems or devices as illustrated in FIG. 1A through FIG. 5, for example. In various embodiments, network interface 660 may support communication via any suitable wired or wireless general data networks, such as types of Ethernet network, for example. Additionally, network interface 660 may support communication via telecommunications/telephony networks such as analog voice networks or digital fiber communications networks, via storage area networks such as Fibre Channel SANs, or via any other suitable type of network and/or protocol.

In some embodiments, system memory 630 may represent one embodiment of a computer-accessible medium configured to store at least a subset of program instructions and data used for implementing the methods and apparatus discussed in the context of FIG. 1A through FIG. 5. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 600 via I/O interface 620. A non-transitory computer-accessible storage medium may also include any volatile or non-volatile media such as RAM (e.g., SDRAM, DDR SDRAM, RDRAM, SRAM, etc.), ROM, etc., that may be included in some embodiments of computing device 600 as system memory 630 or another type of memory. In some embodiments, a plurality of non-transitory computer-readable storage media may collectively store program instructions that when executed on or across one or more processors implement at least a subset of the methods and techniques described above. A computer-accessible medium may further include transmission media or signals such as electrical, electromagnetic, or digital signals, conveyed via a communication medium such as a network and/or a wireless link, such as may be implemented via network interface 660. Portions or all of multiple computing devices such as that illustrated in FIG. 6 may be used to implement the described functionality in various embodiments; for example, software components running on a variety of different devices may collaborate to provide the functionality. In some embodiments, portions of the described functionality may be implemented using storage devices, network devices, or special-purpose computer systems, in addition to or instead of being implemented using general-purpose computer systems. The term “computing device”, as used herein, refers to at least all these types of devices, and is not limited to these types of devices.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g., SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent exemplary embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended to embrace all such modifications and changes and, accordingly, the above description to be regarded in an illustrative rather than a restrictive sense.

What is claimed is:

1. A method for establishing, using a quantum interconnection device, quantum entanglement between a first quantum device and a second quantum device, the method comprising:
receiving, at the quantum interconnection device, a first entangled photon, wherein the first entangled photon is entangled with a first communication qubit of the first quantum device;
performing a heralded, quantum information storage operation between the first entangled photon and a first memory qubit of the quantum interconnection device to transfer the quantum information to the first memory qubit, and such that quantum entanglement is extended to between the first communication qubit of the first quantum device and the first memory qubit of the quantum interconnection device; and
responsive to receiving a second heralding signal that indicates that a separate quantum entanglement has been extended to between a first communication qubit of the second quantum device and a second memory qubit of the quantum interconnection device,
performing a optically-mediated, heralded quantum entanglement operation between the first and second memory qubits, such that quantum entanglement is established between the first communication qubit of the first quantum device and the first communication qubit of the second quantum device.

2. The method of claim 1, wherein:
the first memory qubit is a first optically accessible memory qubit; and
the method further comprises performing a local gate operation to transfer the quantum information to a third memory qubit, wherein the third memory qubit is a first optically inaccessible memory qubit.

3. The method of claim 2, wherein:
the second memory qubit is a second optically accessible memory qubit; and
the method further comprises:
receiving, at the quantum interconnection device, a second entangled photon, wherein the second entangled photon is entangled with the first communication qubit of the second quantum device; and
performing a second heralded, quantum information storage operation between the second entangled photon and the second memory qubit to transfer the second quantum information to the second memory qubit, and such that the quantum entanglement has been extended to between the first communication qubit of the second quantum device and the second memory qubit of the quantum interconnection device.

4. The method of claim 3, wherein the method further comprises performing a second local gate operation to transfer the second quantum information to a fourth memory qubit, wherein the fourth memory qubit is a first optically inaccessible memory qubit.

5. The method of claim 4, wherein the performing the optically-mediated, heralded quantum entanglement operation between the first and the second memory qubits comprises:
emitting a photonic signal from a photon source of the quantum interconnection device along optical pathways to the first and the second memory qubits; and
performing a quantum entanglement generation operation between the first and the second memory qubits based, at least in part, on the photonic signal.

6. The method of claim 5, wherein the performing the optically-mediated, heralded quantum entanglement operation between the first and the second memory qubits further comprises:
performing additional local gate operations between the first and the third memory qubits and between the second and the fourth memory qubits such that the quantum entanglement is established between the first communication qubit of the first quantum device and the first communication qubit of the second quantum device.

7. The method of claim 1, wherein the first and the second memory qubits are located in different optical active quantum memory modules.

8. A method for establishing, using a quantum interconnection device, quantum entanglement between a first quantum device and a second quantum device, the method comprising:
receiving, at the quantum interconnection device, a first entangled photon, wherein the first entangled photon is entangled with a first communication qubit of the first quantum device;
performing a heralded, quantum information storage operation between the first entangled photon and a first memory qubit of the quantum interconnection device to transfer the quantum information to the first memory qubit, and such that quantum entanglement is extended to between the first communication qubit of the first quantum device and the first memory qubit of the quantum interconnection device;
performing a local gate operation to transfer the quantum information to a second memory qubit; and
responsive to receiving a second heralding signal that indicates that a separate quantum entanglement has been extended to between a first communication qubit of the second quantum device and the first memory qubit of the quantum interconnection device,
performing a local, deterministic gate operation between the first and the second memory qubits, such that quantum entanglement is established between the first communication qubit of the first quantum device and the first communication qubit of the second quantum device.

9. The method of claim 8, wherein:
the first memory qubit is a first optically accessible memory qubit; and
the second memory qubit is a first optically inaccessible memory qubit.

10. The method of claim 8, wherein:
the first memory qubit is mapped to an electron of an SiV cavity;
the second memory qubit is mapped to a silicon nucleus of the SiV cavity; and
the local, deterministic gate operation between the first and the second memory qubits is a spin-spin interaction within the SiV cavity.

11. The method of claim 8, wherein the method further comprises:
receiving, at the quantum interconnection device, a second entangled photon, wherein the second entangled photon is entangled with the first communication qubit of the second quantum device; and
performing a second heralded, quantum information storage operation between the second entangled photon and the second memory qubit to transfer the second quantum information to the first memory qubit, and such that the quantum entanglement has been extended to between the first communication qubit of the second quantum device and the first memory qubit of the quantum interconnection device.

12. A system, comprising:
a quantum interconnection device, configured to execute a quantum entanglement protocol to provide quantum entanglement between a first quantum device and a second quantum device, wherein the quantum interconnection device comprises:
optically active quantum memories, configured to store quantum information; and
optical pathways that enable respective ones of the optically active quantum memories to be connected to single photon detectors; and
a classical processor, configured to cause the quantum entanglement protocol to be executed, wherein, to cause the quantum entanglement protocol to be executed, the classical processor is further configured to:
cause a heralded, quantum information storage operation to be performed between respective qubits of the optically active quantum memories; and
responsive to reception of heralding signals via the single photon detectors,
cause a local, deterministic gate operation to be performed between the respective qubits of the optically active quantum memories; or
cause an optically-mediated, heralded quantum entanglement operation between at least the respective qubits of the optically active quantum memories.

13. The system of claim 12, wherein the optical pathways enable an all-to-all connectivity between the optically active quantum memories.

14. The system of claim 12, wherein a given one of the optically active quantum memories comprises:
an optically accessible qubit; and
an optically inaccessible qubit.

15. The system of claim 12, wherein:
a given one of the optically active quantum memories is a silicon-vacancy (SiV) cavity;
an optically accessible qubit of the given one of the optically active quantum memories is mapped to an electron of the SiV cavity; and
an optically inaccessible qubit of the given one of the optically active quantum memories is mapped to a silicon nucleus of the SiV cavity.

16. The system of claim 15, wherein the SiV cavity is a negatively charged SiV cavity.

17. The system of claim 12, wherein, responsive to the reception of the heralding signals, the classical processor is further configured to:
determine that a passage of time between reception of the respective heralding signals is less than a threshold amount of time until expected decoherence of the respective qubits of the optically active quantum memories; and
cause the local, deterministic gate operation or the optically-mediated, heralded quantum entanglement operation to be performed.

18. The system of claim 12, wherein, responsive to the reception of the heralding signals, the classical processor is further configured to:
determine that a passage of time between reception of the respective heralding signals is equal to or greater than a threshold amount of time until expected decoherence of the respective qubits of the optically active quantum memories; and
cause the quantum entanglement protocol to be re-executed.

19. The system of claim 12, wherein, to execute the quantum entanglement protocol, the classical processor is further configured to:
receive a request to establish quantum entanglement between the first quantum device and the second quantum device, using the quantum interconnection device; and
cause the quantum entanglement protocol to be executed, wherein the execution of the quantum entanglement protocol further causes the classical processor to:
receive a first heralding signal, indicating that a first heralded, quantum information storage operation between a first entangled photon, entangled with a first communication qubit of the first quantum device, and a first memory qubit of the quantum interconnection device has been successfully performed;
receive a second heralding signal, indicating that a second heralded, quantum information storage operation between a second entangled photon, entangled with a first communication qubit of the second quantum device, and a second memory qubit of the quantum interconnection device has been successfully performed; and
responsive to the reception of the first and the second heralding signals, the local, deterministic gate operation or the optically-mediated, heralded quantum entanglement operation to be performed between the first and the second memory qubits.

20. The system of claim 19, wherein the classical processor is further configured to:
receive results of the local, deterministic gate operation or the optically-mediated, heralded quantum entanglement operation; and
determine, based on the results, that the quantum entanglement is provided between the first quantum device and the second quantum device.
